(19) United States
(12) Patent Application Publication
(10) Pub. No.: US 2009/0055102 A1
(43) Pub. Date: Feb. 26, 2009

(54) Remote sensor and in-situ sensor system for improved detection of chemicals in the atmosphere and related method thereof

(76) Inventors: Gabriel Laufer, Charlottesville, VA (US); Stephen Keith Holland, Crozet, VA (US); Roland H. Krauss, Charlottesville, VA (US)

Correspondence Address: UNIVERSITY OF VIRGINIA PATENT FOUNDATION, 250 WEST MAIN STREET, SUITE 300, CHARLOTTESVILLE, VA, 22902, US

(21) Appl. No.: 11/665,414

(22) PCT Filed: Oct. 14, 2005
(86) PCT No.: PCT/US05/37030

§ 371 Date: Apr. 13, 2007

Related U.S. Application Data
(60) Provisional application No. 60/619,259, filed on Oct. 15, 2004.

(51) Int. Cl. G01N 31/00; G06F 15/00

(52) U.S. Cl. 702/24; 702/188

(57) ABSTRACT

A system having an optical remote sensor where sensing can be achieved from distance, and therefore without necessarily making contact with the threat chemical, with one or more in-situ sensors where sampling of air is required, and where at least one sensor is cross-reactive. Aspects of some of the various systems capable of achieving, but not limited to thereto, the following advantages: (a) by the optical sensor: long range advanced warning, rapid large volume analysis, fast response continuous monitoring for protection against bursts, safety to the operator, (b) by the in-situ sensor: high sensitivity, (c) by the combination of sensors, high specificity, better avoidance of interferences by chemicals and (d) by the inclusion of cross reactive characteristics, the ability to learn response to new chemicals.

### CROSS-REFERENCE TO RELATED APPLICATIONS

The present invention claims priority under 35 U.S.C. Section 119(e) of the earlier filing date of U.S. Provisional Application Ser. No. 60/619,259, filed Oct. 15, 2004, entitled “Method and System of Combining an Optical Sensor with In-situ Sensor for Improved Detection of Chemicals in the Atmosphere,” which is hereby incorporated by reference herein in its entirety.

### BACKGROUND OF THE INVENTION

Protection of domestic facilities such as office buildings or airports and military targets such as airfields, ships or bases requires reliable detection of threat or polluting chemicals in the air. Such sensors should provide alarms for early warning and therefore must be able to operate continuously, have a fast response, high specificity and sensitivity. In addition, after the detection of a release such sensors should provide capabilities for mapping out the spread of such chemicals as means of predicting down-wind hazards and for planning and managing mitigation efforts. For effective application, sensors may be installed in building air ducts, along facility perimeters, deployed on unmanned vehicles, other vehicles, or used by personnel as handheld units. For wide distribution and accessibility to untrained personnel, sensors must also be simple, robust and low-cost. It is extremely difficult, or even impossible, to have a single sensor that can meet all these requirements. There is a long felt need for a system and method that can achieve all these specifications.

### BRIEF SUMMARY OF INVENTION

Some aspects of various embodiments of the present invention provide, but not limited thereto, a system and method for the monitoring of chemicals in the air or atmosphere. Some aspects of various embodiments of the present invention system endeavor to have, but not limited thereto, the following properties: low-cost, low-maintenance, low-false negative and low-false positive thereby implying sensitive and chemical-specific detection, fast, robust, low energy, low maintenance, and of relatively small size. By combining a plurality of sensors operating on independent physical principles, the combined monitoring system can enjoy the advantages of both of its components while overcoming many of their individual disadvantages.

As an embodiment, for example, by combining an optical remote sensor where sensing can be achieved from distance, and therefore without necessarily making contact with the threat chemical, with one or more in-situ sensors where sampling of air is required, and where at least one sensor is cross-reactive it is possible to achieve, but not limited thereto, the following advantages: (a) by the optical sensor: long range advanced warning, rapid large volume analysis, safety to the operator, (b) by the in-situ sensor: high sensitivity, high specificity, better avoidance of interferences by other, non-target chemicals. For example, when two sensors, each operating on independent physical principles are combined in one monitor, the resulting monitor can be used to provide advanced warning, to map out threat clouds, and then after immersion into the cloud, to reconfirm the threat, to positively identify the chemicals, and to map out the concentration distribution within the cloud. It should be appreciated that depending on the particular arrangement of the various embodiments of the present invention discussed throughout, the remote sensor (optical sensor) is capable of monitoring the same volume or area or partial volume or partial area thereof as monitored by the in-situ monitor. Moreover, it should be appreciated that such monitoring by the remote monitor may be prior to, contemporaneous to, and/or after the monitoring of the in-situ sensor.

Some aspects of the various embodiments of the present invention system and method comprise a combination of an optical remote sensor with in-situ sensors, where at least one of the two sensors is cross-reactive, and can achieve all the desired or required specifications. Various embodiments of the present invention identify the selection criteria for such sensors and provide examples of successful systems and methods.

A specific example of the above-stated preferred embodiment would be to combine a multi-spectral radiometer, e.g., the TOTALLY OPTICAL VAPOR ANALYZER (TOVA) with at least one in-situ sensor that uses absorbing polymers for detection such as surface acoustic wave (SAW) devices, micro cantilever (MC) or the ELECTRONIC NOSE (EN). The following U.S. Patents illustrate the EN and the training process and are hereby incorporated by reference herein in their entirety: U.S. Pat. No. 6,319,724 B1 to Lewis et al., entitled “Trace Level Detection of Analytes Using Artificial Olfactometry;” U.S. Pat. No. 5,959,191 to Lewis et al., entitled “Sensor Arrays for Detecting Analytes in Fluids;” U.S. Pat. No. 5,675,070 to Gelperin, entitled “Olfactory Sensor Identification System and Method;” and U.S. Pat. No. 5,571,401 to Lewis et al., entitled “Sensor Arrays for Detecting Analytes in Fluids.” All these sensors can be packaged as low-cost, robust small size sensors. In addition, these sensors may be cross-reactive, i.e., they include multiple channels that have varying sensitivities to the same chemical. Therefore, they can be “trained” to detect a large array of threat and interfering chemicals even after the hardware is built (they can be adjusted to sense new chemicals as the need arises). Furthermore, if both the optical and in-situ sensors have similar output patterns, the processing of the output data can be simplified, thereby reducing costs and accelerating processing time.

An aspect of an embodiment of the present provides a detection system for detecting chemicals in air. The system comprising: at least one remote sensor adapted to detect at least one chemical; at least one in-situ sensor adapted to detect at least one chemical; and at least one data processor adapted to receive data from at least one remote sensor and at least one in-situ sensor.

An aspect of an embodiment of the present provides a method for detecting chemicals in the air. The method comprising: remotely monitoring an air volume for detecting at least one chemical; in-situ monitoring an air volume for detecting at least one chemical; and analyzing data to determine whether the at least one chemical has been detected either remotely and/or in-situ.

These and other aspects of the disclosed technology and systems, along with their advantages and features, will be made more apparent from the description, drawings and claims that follow.

### DETAILED DESCRIPTION OF THE INVENTION

There is a need in the art, in part due to the increased threat to homeland security, in particular the threat of terrorist attacks involving toxic chemicals, to provide a monitoring system comprising a plurality of sensors that can detect chemicals in atmosphere (See Joseph R. Biden Jr. “When Chemicals Attack”, The Washington Post, p. A13, Aug. 2, 2005, of which is hereby incorporated by reference herein in it's entirety). Such sensors are also useful for environmental protection, monitoring industrial process, medical facilities, etc. To be effective, such sensors are expected to possess (to varying extents in whole or in part) the following characteristics:
a. provide alarms at high level of confidence (i.e., low rate of false positive and low rate of false negative alarms),
b. be fast, i.e., allow scanning large spaces such as airport terminals within a few seconds, or provide fast alarm to burst of chemical releases within approximately one or two seconds,
c. be sensitive to a large number of chemicals (e.g., greater than ten, but may be less than ten if desired),
d. provide continuous monitoring and detection capabilities
e. have the ability to easily expand the list of detectable chemicals,
f. be low-cost (e.g., less than $5,000, but not limited thereto),
g. robust,
h. low maintenance requirements, less than once every three months for example or as per desired or required frequency,
i. easy to operate, even by untrained personnel,
j. portable,
k. low power requirements (a few watts for example, but not limited thereto), and
l. provide high sensitivity, i.e., small fraction of the immediately dangerous to life and health (IDLH) concentrations, thereby allowing detection of slow, persistent releases at low concentration.
   There is no known single sensor that can meet the majority or all of these requirements. By combining two sensors operating on the basis of two different physical principles and having an unrelated (or orthogonal) and complementary characteristics, it is possible to create a monitor that meets most or all of these objectives. Such monitor possesses a unique set of characteristics not possessed by any other current monitor.

For instance, in some embodiments both sensors of the present invention monitoring system may need to meet independently requirements f, g, h, i, k, and l. For example, a system cannot be made low-cost by integrating an expensive sensor with a low-cost sensor. Or a system cannot become portable if one of the two sensors is heavy or bulky. However, even if one of the sensors does not meet any of requirements a, b, c, d, or e, by combining two complementary sensors it is possible to take advantage of their complementary characteristics thereby creating a monitor that meets all the objectives a-l. This disclosure describes the method and system to be used to achieve these objectives and describes several sensor-pairs that meet objectives a-k in whole or in part, as well as to varying extents.

Typically all sensors can be grouped into two categories: in-situ sensors and remote sensors. In-situ sensors detect chemicals in the air by sampling air in their immediate vicinity and analyzing it. For the purpose of this disclosure it should be appreciated that in-situ sensors must be in physical contact with the detected chemical and cannot make any judgment regarding the makeup of air at other locations with which they do not have physical contact. Often, in-situ sensors are regarded as point sensors. In general, in-situ (whether optical or non-optical) sensors cannot be remote, or standoff, or non-contact sensors. An optical but in-situ (i.e., must be in contact with the sample) example includes the Bio/Chem Interferometric Waveguide Sensors developed by Georgia Tech Research Institute (GTRI) (See J. M. Sanders, Sensing Danger, Research Horizon, p. 6-11, Published by the Research Communications Office at the Georgia Institute of Technology, of which is hereby incorporated by reference herein in it's entirety).

By contrast, for the purpose of this disclosure it should be appreciated that remote sensors and certain optical sensors can detect chemicals remotely, i.e., at locations away from the sensor and without physical contact with the target chemical (although remote sensors are not precluded from being in physical contact with the target chemical). Remote sensors and certain optical sensors can identify chemicals, and often determine the chemical concentration and physical spread, even while being outside the cloud formed by those chemicals. An optical but remote (i.e., standoff or non-contact) example includes the differential absorption radiometer (DAR) and TOVA. For the purpose of this disclosure it should be appreciated that remote is defined as standoff or non-contact. An example of a remote optical sensor is illustrated in International Application No. PCT/US00/04027, filed Feb. 18, 2000, entitled “Passive Remote Sensor of Chemicals,” and corresponding U.S. application Ser. No. 09/936,833, filed Sep. 17, 2001, and now U.S. Pat. No. 6,853,452 B1 of which are assigned to the present assignee and are hereby incorporated by reference herein in their entirety.

Examples of optical sensors may include, but not limited thereto, the following: TOTALLY OPTICAL VAPOR ANALYZER (TOVA) type sensor, a differential radiometer absorption type sensor, a Fourier transform type spectrometer or radiometer, a tunable etalon type sensor, a grating based spectrometer type sensor, or a lidar type sensor, or a differential absorption lidar (DIAL) type sensor, or the like.

Examples of in-situ sensors may include, but not limited thereto, the following: in-surface acoustic wave (SAW), micro-cantilever (MC), ELECTRONIC NOSE (EN) type sensor, chemi-resitor type sensor, gas chromatograph type sensor, interferometric type waveguide sensor, chemical paper type sensor, TOTALLY OPTICAL VAPOR ANALYZER (TOVA) type sensor, a differential absorption type sensor, a Fourier transform type spectrometer or radiometer, a tunable etalon type sensor, a grating based spectrometer type sensor, a lidar type sensor, a differential absorption lidar (DIAL) type sensor, or Ion Mobility Spectrometer (IMS), or the like.

Typically remote sensors depend on optical techniques and use certain optical characteristics of the target chemicals for detection. For the purpose of this application, optical techniques are defined as all the techniques that depend on electromagnetic radiation for detection irrespective of the radiation frequency (or wavelength), including but not limited to x-ray, ultraviolet, visible, infrared, microwave and radio frequency radiation. The source of light used with a remote sensor may be natural, man-made or other—the source of light is not considered part of the remote sensor for the purposes of this application. Thus in one application, it is possible to have a radiation source at one location pointing towards the optical sensor at another location and the detection is made of chemicals that are located along the radiation path (line-of-sight) between the radiation source and the optical sensor. For detection, the chemical cloud may fill the entire space between the source and the sensor or may fill only portion of that space.

In another application, the source may be natural, such as infrared emission by a solid target such as a building and a mountain, and the sensor is pointing towards that solid target. For detection, the chemical cloud may fill the entire space between the solid target and the sensor or may fill only portion of that space.

In yet another application, the radiation source may be the sky overhead or over the horizon and the sensor is pointing towards the sky over head or over the horizon. For optical remote sensors operating in the infrared, since the sky is generally colder than its environment, it may be considered a radiation sink. Thus any chemical along the line of sight between the sensor and the sky will be warmer and will be emitting radiation that will be distinguishable from the cold sky background and thus be used for detection.

Since in-situ sensors provide only localized detection, protection of large spaces such as airport terminals or stadiums when only in-situ sensors are available is limited. In the few known cases where in-situ sensors were used for facility protection (e.g., the Washington Metro) numerous sensors were placed in select locations. Accordingly, any release that occurs at a location that is not covered by such sensor will remain undetected. After the release of a toxic chemical—whether deliberate or accidental—successful mitigation efforts require mapping the extent of that release and its spread. When using in-situ sensors, such mapping can be achieved only by transporting that in-situ sensor over the entire affected space thereby rendering the detection process intrusive, dangerous to the operator of the sensor, complex and slow. On the other hand, since remote sensors can remain outside the cloud they can typically cover large volumes rapidly and provide mapping of the threat cloud quickly and without risk to the operator. For example, an infrared remote sensor can analyze, nearly instantaneously, the entire volume along its line of sight. By placing one or several such remote sensors at well-selected locations, the entire volume of the protected space can be covered continuously, quickly and without interruption. Thus to achieve a fast sensor system and method, i.e., protection of large volumes at high speeds, at least one of the sensors must be remote. Even if the protected volume is small, such as the inlet of building ventilation air-ducts, high-speed protection against bursts of chemicals can be achieved by including in the system an optical, non-contact or remote sensor.

In-situ sensors depend on sampling the air for detection. Since many such sensors contain components that may become contaminated or otherwise ineffective after extended exposure to air, pollutants, humidity and other chemicals and contaminants, they must often be kept dormant (i.e., not sampling air and possibly under an atmosphere of inert gas or purge) for some duration. Consequently, while dormant, they cannot provide detection and they become available for sensing only for a limited periods of time. Remote optical sensors (e.g., the TOVA) on the other hand do not require physical contact with contaminated or non-contaminated air and therefore do not become contaminated by the various components of air, do not require purging or dormant periods and can provide uninterrupted, continuous detection. In applications such as the detection in building ventilation air-ducts, the advantage of the non-contact characteristic of the sensor is used to provide continuous detection capabilities instead of detection “from distance” as often is implied by the term “remote sensor.”

Often, in-situ sensors require that the chemicals to be detected absorb to certain surfaces before they can be sensed. This may be a long process that may render the detection time too long relative to the actual needs (e.g., ten seconds to several minutes whereas alarm must be sounded in one to two seconds). Furthermore, after the chemical was absorbed to such surfaces, that chemical and various other contaminants may need to be desorbed before detection of new chemicals can resume. This may require expensive gases (e.g., helium), or a prescribed process such as heating or ionization. These processes require a long recovery duration which may prevent continuous detection and may by themselves be long duration thereby preventing achieving certain important functions, e.g., sounding an alarm on timely manner. Some optical sensors (e.g., the TOVA) on the other hand do not require physical sampling and therefore do not need to undergo a desorption of any absorbed chemicals. Consequently they can respond much faster than many in-situ sensors and avoid the need for costly and complex desorption process such as purging by special gases and can remain available for continuous detection. In applications such as the detection in building ventilation air-ducts, the advantage of the non-contact characteristic of the sensor is used to provide high-speed monitoring capabilities instead of detection “from distance” as often is implied by the term “remote sensor”.

Often in-situ sensors provide very high sensitivity (part per billion). Thus, they can provide effective warning against slow releases at low concentration or trace levels. This is a significant advantage that most optical sensors cannot meet.

Remote sensors can be grouped into two categories, optically active sensors and optically passive sensors. Active sensors use an artificial light source (e.g., a laser or an infrared blackbody source), whereas passive sensors depend on naturally occurring radiation (e.g., the sun or infrared (IR) emission from objects in the field of view) for detection. Typically, low-cost and low-energy operation is achieved more easily by the use of passive remote sensors, so in many applications, remote sensors are preferred. However, remote sensors can also operate in the active mode (i.e., with a man made radiation source along the line of sight).

One of the required characteristics of chemical sensors is to provide sensitivity to a large number of chemicals. In addition it is desired that the list of chemicals that a given sensor can detect be easily updatable. Ideally, by updating the operating software or a database, a sensor can become sensitive to new chemicals whereas chemicals that are no longer considered to be a threat may be removed from the list. Conventional chemical detection systems use a “lock and key” approach where individual sensing elements are designed to strongly and selectively respond to individual chemicals. For example the SenTech 420 MCD integrates individual sensors, each sensitive only to one gas, e.g., H₂S, or HCN. This approach is inflexible. If a new threat chemical is identified, chemical-specific sensors can be updated only by modifying their hardware. Such sensors cannot protect against a wide range of target chemicals and interferants and cannot be easily adjusted to response to continuously varying threats.

“Cross-reactive” sensor arrays provide an alternative strategy with much higher flexibility. Unlike chemical-specific sensors, the array on cross-reactive type sensors includes non-specific sensors, each being sensitive to a group of chemicals, to provide response to any analyte by more than one sensor. When exposed to a given chemical or interferant, the array outputs a unique pattern, similar to a spectrum or fingerprint. Classification and often identification of the chemical is achieved after subtracting a baseline measurement that corresponds to a background, followed by normalization, processing (e.g., vector orthogonalization) and using pattern recognition methods where the processed signature is matched against a library of signatures of known chemicals. The cross-reactive method allows detection and identification of numerous chemicals without specifically designing the sensor to detect any particular chemical. Furthermore, the list of detectable chemicals can be continuously updated by updating a lookup library or automatically, using advanced algorithms such as neural networks. In addition to their flexibility, the cross-reactive sensors proposed here do not require processing, ionizing or breaking the chemicals, thereby being simple and operable over a wide range of environmental conditions.

Usually the specificity of a cross-reactive array increases with the number of detectors within the array and their diversity, in particular when having to distinguish between similar chemicals or identifying chemicals in a binary or complex mixture. Furthermore by combining two different cross-reactive sensors, where each is operating on a different (or unrelated or orthogonal) principle, (a proposed embodiment of the present invention) it is possible to enhance the specificity even further thereby creating a system that can provide an exceptionally low rate of false alarms (positive or negative). For example, by combining an optical remote sensor that includes multiple cross-reactive detectors with a non-optical, in-situ sensor, even if one sensor were to provide a false alarm once every P₁ measurements (1/P₁) and the other sensor every P₂ measurements (1/P₂). The combined rate of false alarms when the two sensors are integrated into one system will be significantly reduced to 1/(P₁P₂).

As discussed throughout this disclosure, an aspect of various embodiments provides the combination of optical remote sensors, where the spectroscopic properties of air in the field of view are analyzed, with in-situ sensors where air is sampled and analyzed. Combining two orthogonal sensors that operate on unrelated (or independent or orthogonal) physical principles reduces the rate of false alarms. Combining two complementary sensors allows for expanding the range of operation of the combined system to provide detection characteristics that cannot be met by any of the sensors alone. Selecting one of the two sensors of the system to be a remote sensor, such as optical remote sensor, allows for fast detection when alarm is necessary, rapidly scanning large volumes from distance thereby providing better area coverage and the ability to map the distribution of threat clouds and continuous monitoring thereby providing protection against sudden unpredictable events. Finally including in the system at least one cross-reactive sensor provides the flexibility necessary to allow for detection of, multiple chemicals and the ability to easily update of the list of chemicals that can be detected by the system.

Thus, some of the aspects of various embodiments of the present invention provide, among other things, a new monitoring system consisting of a plurality of sensors operating on unrelated physical principles where at least one sensor is remote or non-contact, and where at least one sensor is cross-reactive.

Regarding an aspect of an embodiment of the present invention, the monitoring system would not provide a false positive alarm more often than about every 50,000 measurements, each lasting no more than about one minute. Further, no more than about five percent of the system's negative measurements should be false negatives. Note that while the optical remote sensor should complete a measurement in about 1-10 seconds, in many applications it may be acceptable that the confirmation by the in-situ sensor takes longer (e.g., about a minute or more, or as desire or required). Thus, one may sound an alarm even based on the reading of the optical remote sensor, if the concentration or risk appear high. But if the concentration is low, a risk analysis model may suggest repeating the measurement even for about ten minutes until the hazard is confirmed. It should be appreciated that the aforementioned number of measurements, percentage of measurements and durations may be adjusted to a variety of magnitudes as desired or required for a given application.

In another embodiment, the system is able to scan a field of view of about 2.5° in no more than about ten seconds, and preferably in less than about two seconds, more preferably in about one second or less (or as desired or required). It should be appreciated that the aforementioned field of view and durations may be adjusted to a variety of magnitudes as desired or required for a given application.

In another embodiment, the system will be cross-reactive, and will be able detect the presence of at least eight chemicals, preferably more than sixteen chemicals, more preferably more than twenty chemicals (or as desired or required). It should be appreciated that the aforementioned number of chemicals may be adjusted to a variety of magnitudes as desired or required for a give application.

In another embodiment, the system has the capability to expand the list of detectible chemicals, by downloading software, by database modification, or by other means.

In another embodiment, the system will have a standing weight of not more than about twelve pounds, preferably not more than about eight pounds, more preferably not more than about four pounds (or as required or desired). It should be appreciated that the aforementioned weight may be adjusted to a variety of magnitudes as desired or required for a give application.

In another embodiment, the system will run off of commercially available batteries (including rechargeable batteries), such as for example, a Power Sonic PS-1229 battery or other available power sources and means.

In one specific example, the remote sensor consists of several IR detectors (e.g., pyroelectrics or other available IR detectors), each integrated with a bandpass filter transmitting within a selected bandwidth. The center frequencies of the bandpass filters are selected to cover spectral ranges of interest, including but not limited to the 8-11 μm spectral range where emission by solid targets and airborne chemicals peaks and where many toxic chemicals and interferants have strong absorption features and where the atmosphere is nominally transparent. Using naturally occurring radiation avoids the need for expensive, high-power, or bulky radiation sources. The sensors may be coupled optically to a single lens using a radiation modulation and distribution module (RDMM). Accordingly, this remote sensor is cross-reactive because the absorption bands of most chemicals overlap more than one of the spectral bands that are transmitted by the various bandpass filters of the sensor. An example of a radiation modulation and distribution module (RDMM) is International Application No. PCT/US2004/003801, filed Feb. 10, 2004, entitled “System and Method for Remote Sensing and/or Analyzing Spectral Properties of Targets and/or Chemical Species for Detection and Identification thereof,” and corresponding U.S. application Ser. No. 10/544,421, filed Aug. 4, 2005, of which are assigned to the present assignee and are hereby incorporated by reference herein in its entirety.

The in-situ sensor of this example consists of an array of detectors where each detector includes a certain polymer that is designed to selectively absorb a group of chemicals, such as hydrocarbons or cyanides, as well as other chemicals of interest (See Albert, K. J., Lewis, N. S., Schauer, C. L., Sotzing, G. A., Stitzel, S. E., Vaid, T. P. and Walt, D. R., “Cross-Reactive Chemical Sensor Arrays,” Chemical Review, 100:2595-2626, 2000, of which is hereby incorporated by reference herein in it's entirety). Due to that physical absorption, at least one of the physical properties of the polymer is changed. Detection is achieved by measuring the relevant physical properties of all the polymers in that sensor. This selective-absorption technique is currently being used in commercially available sensors that use surface acoustic waves (SAW). Such polymers can also be used in micro-cantilever based sensors (See Chen, G. Y., Thundat, T., Wachter, E. A. and Warmack, R. J., “Absorption-Induced Surface Stress and its Effects on Resonance Frequency of Microcantilevers,” J. of Applied Physics, 77(8):3618-3622, April 1995, of which is hereby incorporated by reference herein in it's entirety). There, individual micro-cantilevers are coated with select polymers. When one or more of the polymers absorb a chemical their cantilever either bends or its resonance frequency changes thereby indicating absorption. Another example is the electronic nose that is manufactured by Smith's Detection. There, polymers are combined with carbon particles to form a composite with a well-defined electrical resistance. When a polymer selectively absorbs a chemical it swells thereby increasing the gap between the carbon particles and thus increasing the electrical resistance. Each of these selectively absorbing polymer techniques is cross-reactive and thus can be effectively combined with the optical remote sensor to achieve together all the objectives a-l listed above, or in part, as well as varying extent.

Examples of possible applications include installation of an optical IR sensor and an in-situ sensor in building heating ventilation and air-conditioning (HVAC) ducts to provide protection against accidental or intentional release of toxic industrial chemicals (TICs). Installation of an optical remote sensor on an unmanned vehicle or the like is contemplated whereby the remote sensor is used to search, detect, and provide initial identification of toxic or polluting chemicals in the atmosphere. Once such chemical is detected, the vehicle enters the area where the chemical is suspected to be and samples the air using an in-situ sensor to confirm the detection. The remote sensor can be used before or after the confirmation by the in-situ sensor to map the spread of the chemical. In yet another embodiment, the remote sensor can be packaged as a handheld sensor (or robot mounted or mounted on any other vehicle) to be operated by a person whereas the in-situ sensor is integrated with a small-unmanned vehicle. Once the operator detects a suspected cloud he or she (or a robotic controller) can direct the vehicle with the in-situ sensor to sample the air and confirm the detection or he or she may enter the cloud and provide confirmation by repeating the measurement with the in-situ sensor and with the remote sensor.

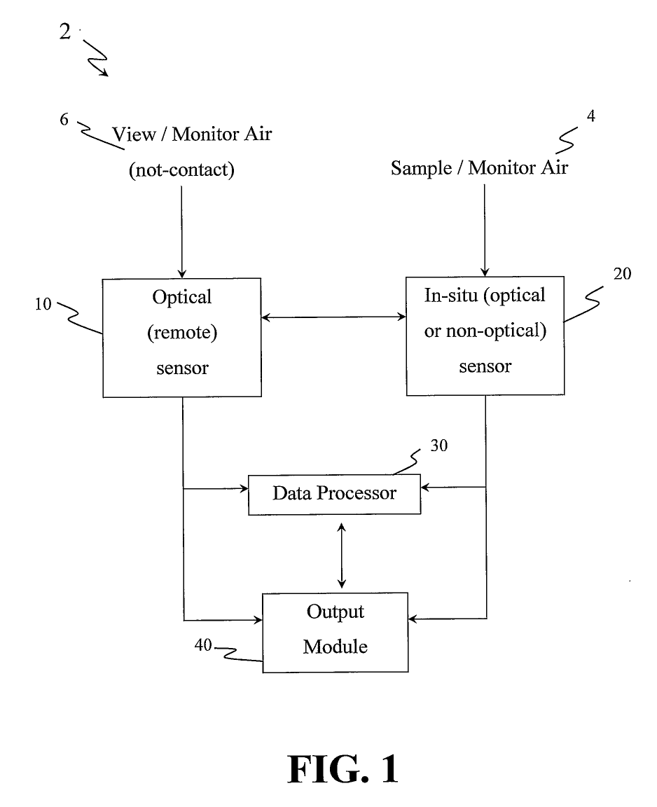

Turning to FIG. 1, FIG. 1 illustrates schematic block diagram of an aspect of an embodiment of the present invention detection system 2 comprising at least one remote sensor 10 in communication with at least one in-situ sensor 20 wherein at least one data processor 30 is adapted for analyzing output or data received from the remote sensor 10 and in-situ sensor 20 for detection in a given atmosphere, which may include surrounding area, vicinity, volume, container, enclosure, duct, dwelling, vehicle, or environment. Any of the aforementioned components of the detection system may be in communication with an output module 40 that may be any one of a variety of devices or systems such as but not limited thereto the following: alarm, memory, data storage device such as a computer hard drive, computer network, television screen or monitor, printer, recording device, communication device, telephone, computer, another processor, or recorder or any combination thereof. The in-situ sensor 20 may detect chemicals in the air or atmosphere by sampling air 4 in their immediate vicinity and analyzing it. The in-situ sensors 20 must be in physical contact with the detected chemical and cannot make any judgment regarding the makeup of air at other locations with which they do not have physical contact. The in-situ sensor 20 may be an optical sensor on a non-optical sensor.

Still referring to FIG. 1, the remote sensors 10 and certain optical sensors can detect chemicals remotely, i.e., at locations away from the sensor and without physical contact with the target chemical. The remote sensors 10 can detect analytes without contacting the air and by viewing air 6 or radiation that passed through the air from a natural or man made source. Although, it should be appreciated that remote sensors are not precluded from being in physical contact with the target chemical. Remote sensors can identify chemicals, and often determine their concentration, even while being outside the cloud formed by those chemicals. The remote sensor 10 may include certain optical sensors. As mentioned previously, remote is defined as standoff or non-contact.

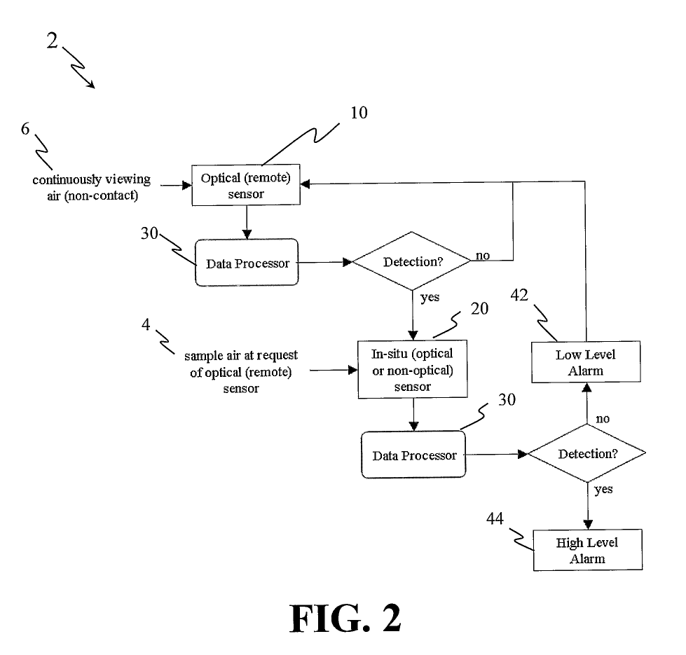

Turning to FIG. 2, FIG. 2 illustrates an exemplary flow chart of an aspect of an embodiment of the present invention detection system 2 comprising at least one remote sensor 10 in communication with at least one in-situ sensor 20 wherein at least one data processor 30 is adapted for analyzing output or data received from the remote sensor 10 and in-situ sensor 20 for detection in a given atmosphere. Any of the aforementioned components of the detection system may be in communication with an output module such as an alarm (or other hardware or system as desired or required) that may be any predetermined magnitude, such as a low-level alarm 42 or high-level alarm 44. The exemplary flow chart provides for the remote sensor 10 to continuously monitor (e.g., view or the like) the air 6. However, it should be appreciated that the monitoring (e.g., viewing) by the remote sensor may include semi-continuous, intermittent, random, scheduled or staggered as required or desired. The exemplary flow chart provides for the in-situ sensor 20 to sample the air 4 at the request of the optical sensor 10 output or data there from (for example when a threat chemical is detected by the remote sensor and confirmation of that detection is needed). However, it should be appreciated that the sampling format by the in situ sensor may include continuous, semi-continuous, intermittent, scheduled or staggered as required or desired. In this configuration, if both sensors detect a threat, a high level alarm may be sounded, where such high level alarm may require certain predetermined actions such as sealing a building, sounding an audible alarm, alerting guards, etc. If only the in situ sensor provides a detection of a threat chemical, this system configuration will provide a low level alarm which may include but not limited to, repeat of the measurement by the optical sensor with a special attention to the recognized threat, closing a damper on the ventilation air duct, alerting the guards, etc.

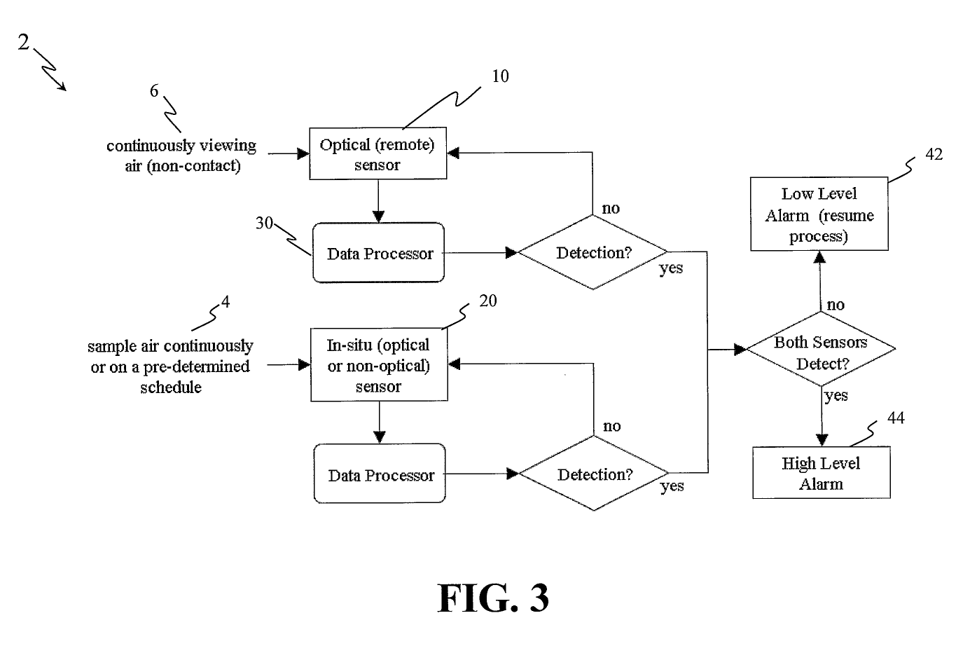

Turning to FIG. 3, FIG. 3 illustrates an exemplary flow chart of an aspect of an embodiment of the present invention detection system 2 comprising at least one remote sensor 10 in communication with at least one in-situ sensor 20 wherein at least one data processor 30 is adapted for analyzing output or data received from the remote sensor 10 and in-situ sensor 20 for detection in a given environment. Any of the aforementioned components of the detection system may be in communication with an output module such as an alarm (or other hardware or system as desired or required) that may be any predetermined magnitude, such as a low-level alarm 42 or high-level alarm 44. The exemplary flow chart provides for the remote sensor 10 to continuously monitor (e.g., view) the air 6 or radiation that passed through the air from a natural or man made source. However, it should be appreciated that the monitoring (e.g., viewing) may include semi-continuous, intermittent, random, scheduled or staggered as required or desired. The exemplary flow chart provides for the in-situ sensor 20 continuously sample the air 6 or on a predetermined schedule and independently from the optical remote sensor 10. However it should be appreciated that the sampling may include semi-continuous, intermittent, random or staggered as required or desired. The low-level alarm 42 may include, but is not limited to, detection of a threat chemical by only one sensor, or detection of low concentration by both sensors. Often a low level alarm will trigger a repeated measurement or a warning that may be registered in a log or a warning to a supervisor. The high level alarm 44 may include, but is not limited to, detection of a threat chemical by both detectors, detection of a threat chemical by only one detector but a dangerous level, detection of a particularly toxic chemical even at a low level, detection of any particular chemical at any level by any of the detectors when there is already an outstanding warning (e.g., through news report or government report) that the particular chemical has been released and is now threatening the protected facility.

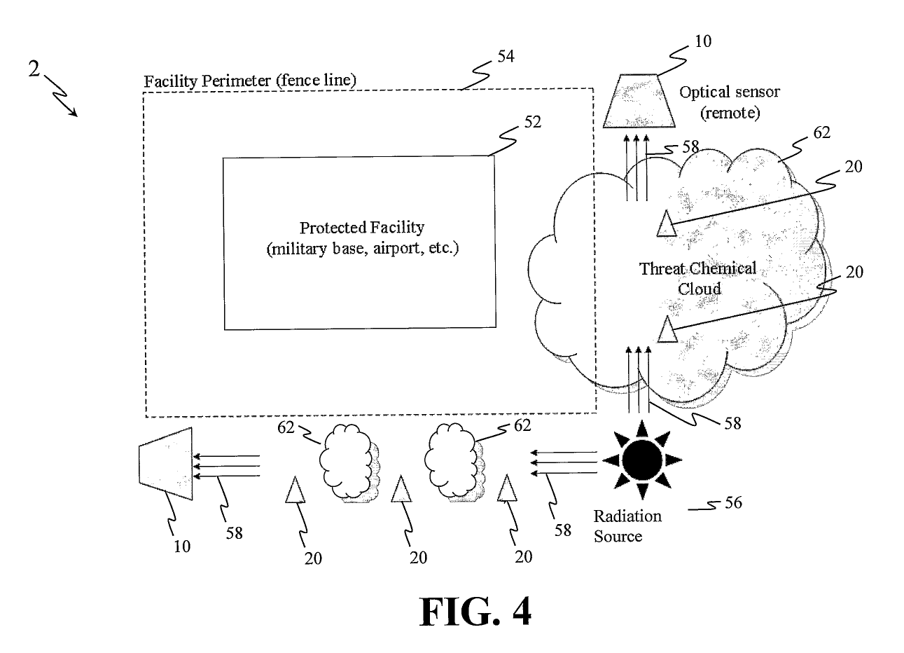

Turning to FIG. 4, FIG. 4 is a schematic illustration of an application of an aspect of the present invention detection system 2 that may be used for facility protection and the detection of chemicals in the vicinity around a facility 52 or structure, such as but not limited thereto the following: military base, airports, schools and university buildings, government buildings, commercial properties, residences or the like. This particular application is often called “perimeter protection” or “fixed security”. The area for detection could be at the facility 52 or any surrounding area (interior or exterior) or structure such as facility perimeter 54, e.g., fence line. Thus in one application, it is possible to have a radiation source 56, either artificial or naturally occurring, at one location pointing towards the remote sensor 10 (e.g. optical) at another location and the detection is made of chemicals that are located along the radiation path (line-of-sight 58) between the radiation source 56 and the remote sensor 10 (e.g., optical). For detection, the chemical cloud 62 may fill the entire space between the source 56 and the sensor 10 (as generally shown to the right side of the facility 52 as illustrated in FIG. 4) or may fill only portion of that space (as generally shown to the lower side of the facility 52 as illustrated in FIG. 4). In-situ sensors 20 may also be distributed along the facility perimeter 54 near the radiation path of the optical sensor to provide confirmation of threats detected by the optical remote sensor and to monitor and provide alarm for low-concentration threats.

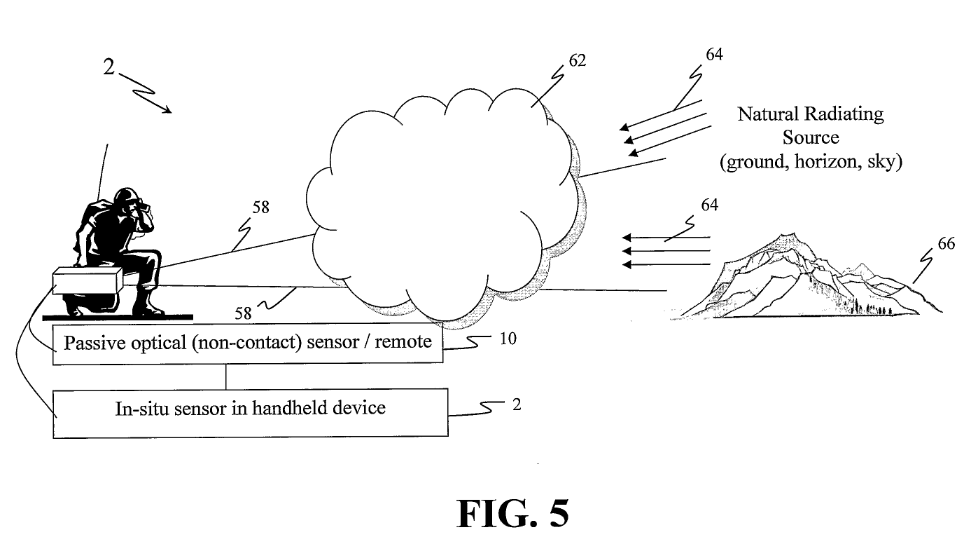

Turning to FIG. 5, FIG. 5 is a schematic illustration of an application of an aspect of the present invention detection system 2 that may be used for the detection of chemicals in the vicinity of a target wherein the source may be natural, such as naturally occurring infrared emission 64 by a target with no artificial radiation source. For example, the target may be a solid target such as a building or mountain 66 and the remote sensor 10 (optical sensor) is pointing towards the mountain 66. Or the source may be the sky where the remote sensor 10 is pointing above the horizon or upwards. For optical remote sensors operating in the infrared spectral region, since the sky is colder than its environment, it may be considered as radiation sink. Thus any chemical along the line of sight 58 between the remote sensor 10 and the sky will be warmer and will be emitting radiation 64 that will be distinguishable from the clod sky background and thus be used for detection. A natural source for this invention may also include a man made radiation source such as a street light or the warm hood of a car, but when such source occurs independently of the remote sensor 10 and is not an integral part of the sensor. For detection, the chemical cloud 62 may fill the entire space between the solid target (mountain 66) and the remote sensor 10 along the line of sight 58 or may fill only portion of that space (e.g., area or volume). As such, the remote sensor 10 does not necessarily make contact with the chemical cloud 62. An in-situ sensor 20, either integrated with the remote sensor 10, or mounted on a separate platform, may be used to enter and sample the air in the region of a suspected chemical threat after detection is made with the optical sensor 10, providing confirmation of the threat and reducing the false-alarm rate of the combined sensing system. After the threat is confirmed with the in-situ sensor 20, the optical sensor 10 may be used to map the spread of the analyte.

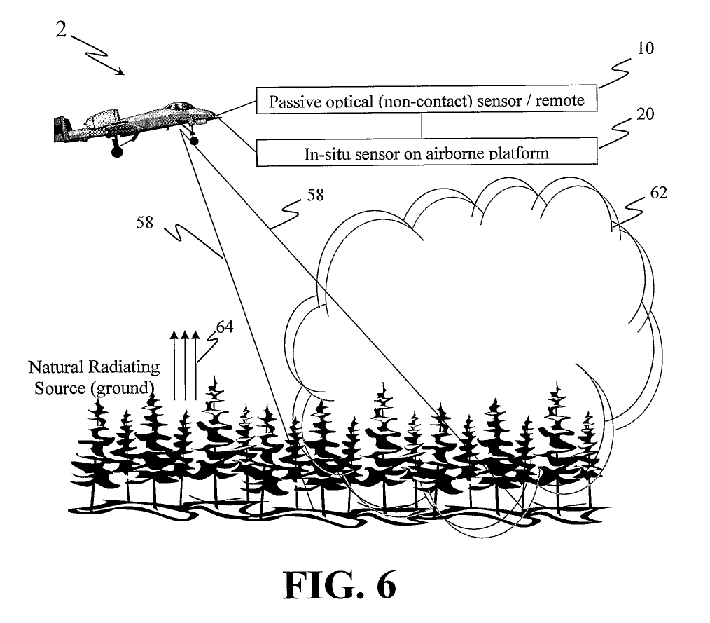

Referring to FIG. 6, FIG. 6 is a schematic illustration of an application of an aspect of the present invention detection system 2 that may be used for the detection of chemicals on the ground and where the remote sensor is carried on an air vehicle 68 such as an airplane, unmanned air vehicle, helicopter, balloon, airship, kite, parachute, satellite, etc. It should be appreciated that the sensor may also be mounted on ground or sea bound vehicles and in such applications, the sensor may point horizontally, downward or upward. The sensor may be used for the detection of chemicals on the ground wherein the radiation source may be the ground itself and radiation reflected and scattered by the ground, including the sun, the atmosphere or the sky. For example, an aircraft 68, or another vehicle, may survey a region and detect a chemical cloud 62 without contact and may further maneuver the aircraft 68 into the chemical cloud to detect a chemical with contact of the chemical for detection by the in-situ-sensor 20 aboard the aircraft 68.

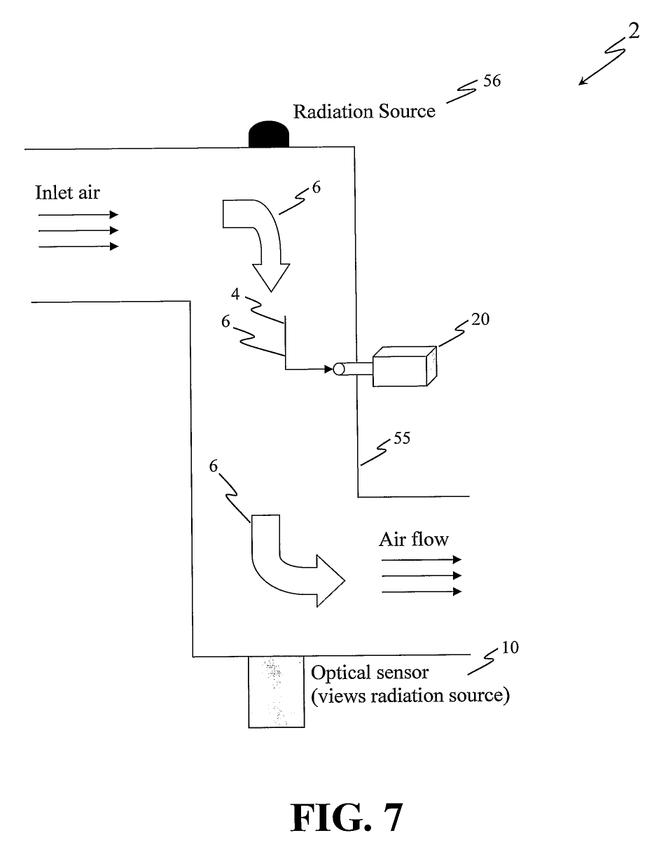

Referring to FIG. 7, FIG. 7 is a schematic illustration of an application of an aspect of the present invention detection system 2 that may be used for the detection of chemicals in building heating ventilation and air-conditioning (HVAC) ducts 55 to provide protection against accidental or intentional release of toxic industrial chemicals (TICs) or applicable chemical threat. Thus in one application, it is possible to have a radiation source 56, artificial or naturally occurring, at one location pointing towards the remote sensor 10 (e.g. optical) at another location and the detection is made of chemicals that are located along the radiation path 57 and line-of-sight 58 between the radiation source 56 and the remote sensor 10 (e.g., optical sensor). For detection, the inlet air 7 move chemical particles or cloud 62 through the duct 55 that may fill the entire space between the source 56 and the sensor 10 or may fill only portion of that space. In-situ sensors 20 may also be distributed along duct 55 near the radiation path 57 of the optical sensor 10 to provide confirmation of high concentration threats detected by the optical remote sensor 10 and to monitor and provide alarm for low-concentration threats or for threats that cannot be detected by the remote sensor 10. The in-situ sensor 20 samples/monitors the air 4 from the HVAC duct 55 or similar structures or the like. Similarly, the remote sensor 10 may monitor and provide alarm against threats that cannot be detected by the in-situ sensor 20. The remote sensor 10 views/monitors the air 6 from the HVAC duct 55 or similar structures or the like. In an exemplary application for detection in building ventilation air-ducts, an advantage of the non-contact characteristic of the remote sensor is used to provide continuous detection capabilities instead of detection “from distance” as often is implied by the term “remote sensor.” Also, in an application such as for detection in building ventilation air-ducts, an advantage of the non-contact characteristic of the remote sensor is used to provide high-speed monitoring capabilities instead of detection “from distance” as often is implied by the term “remote sensor.” The volume of air monitored by at least one remote sensor and the volume of air monitored by at least one in situ sensor may be fully or partially overlapping each other, as well as non-overlapping each other.

Still referring to FIG. 7, an advantage of associated with aspects of such a system is that although remote sensors may be intended to protect large volumes whereas the protected volume in this exemplary embodiment may be small, as may be the case of an inlet of building ventilation air-ducts, high-speed protection against bursts of chemicals can be achieved by an optical, non-contact or remote sensor. Another advantage of the remote sensor 10 in this embodiment is that it can monitor the protected volume continuously thereby providing protection against sudden bursts of high concentration chemical threats. Additionally, if only the in situ sensor provides a detection of a threat chemical, this system configuration may provide a low level alarm which may include but not limited to, repeat of the measurement by the optical sensor with a special attention to the recognized threat, closing a damper on the ventilation air duct, alerting the guards, etc.

Next, it should be appreciated that the communication of data and information transferred among the modules and components (e.g, in-situ sensor 20, remote sensor 10, data processor 30, output module 40, etc.) of the Chemical detection/monitoring system 2 discussed throughout this document may be implemented using software and data transferred via communications interfaces that are in the form of signals, which may be electronic, electromagnetic, optical, RF, infrared or other signals capable of being received by communications interfaces. The signals may be provided via communications paths or channels (or any other communication means or channel disclosed herein or commercially available) that carries signals and may be implemented using wire or cable, fiber optics, integrated circuitry, a phone line, a cellular phone link, an RF link, an infrared link and other communications channels/means commercially available.

Other examples of the output module 40 may include a computer user interface/graphic user interface that may include various devices such as, but not limited thereto, input devices, mouse devices, keyboards, monitors, printers or other computers and processors. The computer/graphic user interface may be local or long distance to the system 2. It should be appreciated that there may be one or more computer user interface/graphic user interface that may be in communication with any of the components, modules, instruments, devices, vehicles, systems and equipment discussed herein. For example, the computer user interface/graphic user interface may be located locally or long distance. Such a remote communication of the computer user interface/graphic user interface may be accomplished a number of way including an uplink/communication path to a cell telephone network (e.g., external device/system) or satellite (e.g., external device/system) to exchange data with a central processing point (e.g., external device/system 1520).

The detection/monitoring system 2 may also be in communication with an external device(s) or system(s) such as at least one of the following transmitters, receivers, controllers/processors, computers, satellites, telephone cell network, PDA's, workstations, and other devices/systems/instruments/equipment/sensors. The aforementioned external device/systems may be comprised of one or plurality and may be locally and/or long-distance located.

Further, the detection/monitoring system 2 may also comprise or be in communication with an auxiliary system/device/instrument/sensor, as well as a plurality of such systems/devices/instruments. Such auxiliary system/device/instrument/sensor may include, but not limited thereto, the following: communication device/system, robot, global positioning system (GPS), positioning device/system, vehicles, or any other device/system/instrument/sensor as desired or required. The aforementioned auxiliary device/system/instrument/sensor may be comprise of one or plurality and may be locally and/or long-distance located.

Still yet, examples of the data processor 30 may be a variety of processors or controllers implemented using hardware, software or a combination thereof and may be implemented in one or more computer systems or other processing systems, such as general purpose computer or personal digital assistants (PDAs). Further, the data processor 30 as discussed throughout may be a single processor or multiple processors for a given sensor/monitor system 2.

Further yet, it should be appreciated that any of the modules and components (e.g, in-situ sensor 20, remote sensor 10, data processor 30, output module 40) for a given sensor/monitoring system 2 may be all integrated together in one housing or may be separate components or any combination there of whereby some of the modules and components are integrated together and some are not.

One skilled in the art can appreciate that many other embodiments of detection system and method, and other details of construction constitute non-inventive variations of the novel and insightful conceptual means, system and technique which underlie the present invention.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particularly interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

We claim:

1. A detection system for detecting chemicals in air, said system comprising:
at least one remote sensor adapted to detect at least one chemical;
at least one in-situ sensor adapted to detect at least one chemical; and
at least one data processor adapted to receive data from said at least one remote sensor and said at least one in-situ sensor.

2. The system of claim 1, wherein said data processor determines whether one or more chemicals have been detected by at least one of said at least one remote sensor and said at least one in-situ sensor.

3. The system of claim 2, wherein said data processor transmits detected data to an output module.

4. The system of claim 3, wherein said output module comprises at least one of the following: alarm, recorder, printer, communication device, computer network, hardware or software user interface, other sensors or sensor arrays, or display or any combination thereof.

5. The system of claim 1, wherein said at least one remote sensor comprises an optical sensor.

6. The system of claim 5, wherein said optical sensor comprises at least one of TOTALLY OPTICAL VAPOR ANALYZER (TOVA) type sensor, a differential radiometer absorption type sensor, a Fourier transform type spectrometer or radiometer, a tunable etalon type sensor, a grating based spectrometer type sensor, or a lidar type sensor, a differential absorption lidar (DIAL) type sensor, or any combination thereof.

7. The system of claim 1, wherein at least one of said at least one remote sensor and/or said at least one in-situ sensor comprises a cross-reactive type sensor.

8. The system of claim 7, wherein at least one of said at least one remote sensor and/or said at least one in-situ sensor comprises an optically passive type sensor or an optically active type sensor, or combination of both optically active and passive type sensors.

9. The system of claim 1, wherein at least one of said at least one remote sensor and/or said at least one in-situ sensor comprises an optically passive type sensor or optically active type sensor, or combination of both optically active and passive type sensors.

10. The system of claim 1, wherein said at least one in-situ sensor comprises at least one of the following types of sensors: surface acoustic wave (SAW), micro-cantilever (MC), ELECTRONIC NOSE (EN) type sensor, chemi-resitor type sensor, gas chromatograph type sensor, interferometric type waveguide sensor, chemical paper type sensor, TOTALLY OPTICAL VAPOR ANALYZER (TOVA) type sensor, a differential absorption type sensor, a Fourier transform type spectrometer or radiometer, a tunable etalon type sensor, a grating based spectrometer type sensor, a lidar type sensor, a differential absorption lidar (DIAL) type sensor, or Ion Mobility Spectrometer (IMS), or any combination thereof.

11. The system of claim 1, wherein said at least one remote sensor is adapted to monitor air without contact with the chemical and said at least one in-situ sensor is adapted to sample air by contact with the chemical

12. The system of claim 11, wherein said at least one remote sensor comprises an optical sensor.

13. The system of claim 12, wherein said optical sensor comprises at least one of TOVA type sensor, a differential absorption radiometer type sensor, a Fourier transform type spectrometer or radiometer, a tunable etalon type sensor, a grating based spectrometer type sensor, a lidar type sensor, a differential absorption lidar (DIAL) type sensor, or any combination thereof.

14. The system of claim 11, wherein at least one of said at least one remote sensor and/or said at least one in-situ sensor comprises a cross-reactive type sensor.

15. The system of claim 14, wherein at least one of said at least one remote sensor and/or said at least one in-situ sensor comprises an optically passive type sensor or an optically active type sensor, or combination of both optically active and passive type sensors.

16. The system of claim 11, wherein at least one of said at least one remote sensor and/or said at least one in-situ sensor comprises an optically passive type sensor or an optically active type sensor, or combination of both optically active and passive type sensors.

17. The system of claim 3, wherein said at least one in-situ sensor comprises at least one of the following types of sensors: surface acoustic wave (SAW), micro-cantilever (MC), ELECTRONIC NOSE (EN) type sensor, chemi-resitor type sensor, gas chromatograph type sensor, interferometric waveguide sensor, a TOTALLY OPTICAL VAPOR ANALYZER (TOVA) type sensor, a differential absorption type sensor, a Fourier transform type spectrometer or radiometer, a tunable etalon type sensor, a grating based spectrometer type sensor, a lidar type sensor, a differential absorption lidar (DIAL) type sensor, or Ion Mobility Spectrometer (IMS), or any combination thereof.

18. The system of claim 11, wherein said data processor is adapted to determine whether one or more chemicals have been detected by at least one of said at least one remote sensor and said at least one in-situ sensor.

19. The system of claim 18, wherein:
if said data processor determines whether one or more chemicals have been detected by said at least one remote sensor, then
said data processor determines whether one or more chemicals have been detected by said at least one in-situ sensor.

20. The system of claim 19, wherein said data processor transmits detected data to an output module.

21. The system of claim 20, wherein said output module comprises at least one of the following: low level alarm, alarm, recorder, printer, communication device, computer network, computer network (internet), hardware or software user interface, other sensors or sensor arrays, or display or any combination thereof.

22. The system of claim 20, wherein said data processor transmits detected data to an output module to provide a low level alarm to initiate a repeat detection by said at least one remote sensor.

23. The system of claim 19, wherein said at least one remote sensor continuously monitors the air.

24. The system of claim 19, wherein said at least one remote sensor monitors the air in the following mode: semi-continuously, randomly, intermittently or scheduled basis, or any combination thereof.

25. The system of claim 18, wherein:
if said data processor determines whether one or more chemicals have been detected by said at least one in-situ sensor, then
said data processor determines whether one or more chemicals have been detected by said at least one remote sensor.

26. The system of claim 25, wherein said data processor transmits detected data to an output module.

27. The system of claim 26, wherein said output module comprises at least one of the following: low level alarm, alarm, recorder, printer, communication device, computer network, computer network (internet), hardware or software user interface, other sensors or sensor arrays, or display or any combination thereof.

28. The system of claim 26, wherein said data processor transmits detected data to an output module to provide a low level alarm to initiate a repeat detection by said at least one remote sensor.

29. The system of claim 25, wherein said at least one remote sensor continuously monitors the air.

30. The system of claim 25, wherein said at least one remote sensor monitors the air in the following mode: semi-continuously, randomly, intermittently or scheduled basis, or any combination thereof.

31. The system of claim 11, wherein:
said data processor determines whether one or more chemicals have been detected by said at least one remote sensor, and
said data processor determines whether one or more chemicals have been detected by said at least one in-situ sensor.

32. The system of claim 31, wherein at least one of said at least one remote sensor continuously monitors the air and said at least one in-situ sensor continuously samples the air.

33. The system of claim 31, wherein:
at least one of said at least one remote sensor air monitors the air in the following mode: semi-continuously, randomly, intermittently or scheduled basis, or any combination thereof, and
said at least one in-situ sensor detector continuously sample the air in the following mode: semi-continuously, randomly, intermittently or scheduled basis, or any combination thereof.

34. The system of any one of claims 31-33, wherein said data processor transmits detected data to an output module.

35. The system of claim 34, wherein said output module comprises at least one of the following: alarm, recorder, printer, communication device, computer network, hardware or software user interface, other sensors or sensor arrays, or display or any combination thereof.

36. The system of claim 34, wherein said data processor transmits detected data to an output module to provide a low level alarm to initiate a repeat detection by said at least one remote sensor.

37. The system of claim 36, wherein said at least one remote sensor comprises an optical sensor.

38. The system of claim 37, wherein said optical sensor comprises at least one of TOTALLY OPTICAL VAPOR ANALYZER (TOVA) type sensor, a differential radiometer absorption type sensor, a Fourier transform type spectrometer or radiometer, a tunable etalon type sensor, a lidar type sensor, a differential absorption lidar (DIAL) type sensor, or a grating based spectrometer type sensor, or any combination thereof.

39. The system of claim 36, wherein at least one of said at least one remote sensor and/or said at least one in-situ sensor comprises a cross-reactive type sensor.

40. The system of claim 39, wherein at least one of said at least one remote sensor and/or said at least one in-situ sensor comprises an optically passive type sensor or an optically active type sensor, or combination of both optically active and passive type sensors.

41. The system of claim 36, wherein said at least one in-situ sensor comprises at least one of the following types of sensors: surface acoustic wave (SAW), micro-cantilever (MC), ELECTRONIC NOSE (EN) type sensor, chemi-resitor type sensor, gas chromatograph type sensor, interferometric type waveguide sensors, chemical paper type sensor, TOTALLY OPTICAL VAPOR ANALYZER (TOVA) type sensor, a differential absorption type sensor, a Fourier transform type spectrometer or radiometer, a tunable etalon type sensor, a grating based spectrometer type sensor, a lidar type sensor, a differential absorption lidar (DIAL) type sensor, or Ion Mobility Spectrometers (IMS), or any combination thereof.

42. The system of claim 1, wherein said at least one remote sensor is adapted to monitor and/or sample the air and said at least one in-situ sensor is adapted to monitor and/or sample the air, wherein:
the volume of air monitored and/or sampled by said at least one remote sensor and the volume of air monitored and/or sampled by said at least one in situ sensor are fully or partially overlapping each other.

43. The system of claim 42, wherein said monitoring and/or sampling of fully or partially overlapping volumes of air by said at least one remote sensor and by said at least one in-situ sensor occurs simultaneously.

44. The system of claim 42, wherein said monitoring and/or sampling of fully or partially overlapping volumes of air occurs whereby said at least one remote sensor performs detection prior to said at least one in-situ sensor performs detection.

45. The system of claim 42, wherein said monitoring and/or sampling of fully or partially overlapping volumes occurs whereby said at least one in-situ sensor performs detection prior to said at least one remote sensor performs detection.

46. The system of claim 1 wherein said at least one remote sensor is adapted to monitor and/or sample the air and said at least one in-situ sensor is adapted to monitor and/or sample the air, wherein:
the volume of air monitored and/or sampled by said at least one remote sensor and the volume of air monitored and/or sampled by said at least one in situ sensor are non-overlapping each other.

47. The system of claim 46, wherein said monitoring and/or sampling of non-overlapping volumes of air by said at least one remote sensor and by said at least one in-situ sensor occurs simultaneously.

48. The system of claim 46, wherein said monitoring and/or sampling of non-overlapping volumes of air occurs whereby said at least one remote sensor performs detection prior to said at least one in-situ sensor performs detection.

49. The system of claim 46, wherein said monitoring and/or sampling of non-overlapping volumes occurs whereby said at least one in-situ sensor performs detection prior to said at least one remote sensor performs detection.

50. A method for detecting chemicals in the air, said method comprising:
remotely monitoring an air volume for detecting at least one chemical;
in-situ monitoring an air volume for detecting at least one chemical; and
analyzing data to determine whether the at least one chemical has been detected either remotely and/or in-situ.

51. The method of claim 50, wherein
said remote monitoring comprises avoiding contact with the chemical in the air volume; and
said in-situ sensor monitoring comprising sampling air in the air volume by contacting the chemical.

52. The method of claim 51, wherein:
if said analyzing determines whether one or more chemicals have been detected by said remote monitoring, then
said analyzing subsequently determines whether chemicals have been detected by said in-situ monitoring.

53. The method of claim 51, wherein:
if said analyzing determines whether one or more chemicals have been detected by said in-situ monitoring, then
said analyzing subsequently determines whether chemicals have been detected by said remote monitoring.

54. The method of claim 51, wherein said remote monitoring is continuous and said in-situ monitoring is continuous.

55. The method of claim 51, wherein said remote monitoring is continuous and said in-situ monitoring is non-continuous.

56. The method of claim 51, wherein the volume of air monitored by said remote monitoring and the volume of air monitored by said in-situ monitoring overlap each other fully or partially.

57. The method of claim 56, wherein said monitoring of fully or partially overlapping volumes occurs simultaneously.

58. The method of claim 56, wherein said monitoring of fully or partially overlapping volumes of air occurs whereby said remote monitoring occurs prior to said in-situ monitoring.

59. The method of claim 56, wherein said monitoring of fully or partially overlapping volumes of air occurs whereby said in-situ monitoring occurs prior to said remote monitoring.

60. The method of claim 51 wherein the volume of air monitored by said remote monitoring and the volume of air monitored by said in-situ monitoring do not overlap each other.

61. The method of claim 60, wherein said monitoring non-overlapping volumes occurs simultaneously.

62. The method of claim 60, wherein said monitoring of non-overlapping volumes of air occurs whereby said remote monitoring occurs prior to said in-situ monitoring.

63. The method of claim 60, wherein said monitoring of non-overlapping volumes of air occurs whereby said in-situ monitoring occurs prior to said remote monitoring.

64. The method of claim 51, wherein said remote monitoring is continuous and said in-situ monitoring is non-continuous and is occurring on a pre-determined schedule.

65. The method of claim 51, wherein said remote monitoring is continuous and said in-situ monitoring is non-continuous and is occurring on a random schedule

66. The method of claim 51, wherein said remote monitoring is continuous and said in-situ monitoring is non-continuous and is occurring on command.

67. The method of claim 50, wherein:
if said analyzing determines whether one or more chemicals have been detected by said remote monitoring, then
said analyzing subsequently determines whether chemicals have been detected by said in-situ monitoring.

68. The method of claim 50, wherein:
if said analyzing determines whether one or more chemicals have been detected by said in-situ monitoring, then
said analyzing subsequently determines whether chemicals have been detected by said remote monitoring.

69. The method of claim 50, wherein said remote monitoring is continuous and said in-situ monitoring is continuous.

70. The method of claim 50, wherein said remote monitoring is continuous and said in-situ monitoring is non-continuous.

71. The method of claim 50 wherein, said remote monitoring is continuous and said in-situ monitoring is non-continuous and is occurring on a pre-determined schedule.

72. The method of claim 50, wherein said remote monitoring is continuous and said in-situ monitoring is non-continuous and is occurring on a random schedule

73. The method of claim 50, wherein said remote monitoring is continuous and said in-situ monitoring is non-continuous and is occurring on command.

74. The method of claim 50, wherein said remote monitoring and said in situ monitoring monitor volumes of air that overlap each other fully or partially.

75. The method of claim 74, wherein said full overlap and/or partial overlap monitoring occurs simultaneously.

76. The method of claim 74, wherein said full overlap and/or partial overlap monitoring occurs whereby said remote monitoring occurs prior to said in-situ monitoring.

77. The method of claim 74, wherein said full overlap and/or partial overlap monitoring occurs whereby said in-situ monitoring occurs prior to said remote monitoring.

78. The method of claim 74, wherein said remote monitoring is continuous and said in-situ monitoring is continuous.

79. The method of claim 74, wherein said remote monitoring is continuous and said in-situ monitoring is non-continuous.

80. The method of claim 74, wherein said remote monitoring is continuous and said in-situ monitoring is non-continuous and is occurring on a pre-determined schedule.

81. The method of claim 74, wherein said remote monitoring is continuous and said in-situ monitoring is non-continuous and is occurring on a random schedule

82. The method of claim 74, wherein said remote monitoring is continuous and said in-situ monitoring is non-continuous and is occurring on command.

83. The method of claim 50 wherein said remote monitoring and said in situ monitoring monitor volumes of air that do not overlap each other.

84. The method of claim 83, wherein said non-overlapping monitoring occurs simultaneously.

85. The method of claim 83, wherein said non-overlapping monitoring occurs whereby said remote monitoring occurs prior to said in-situ monitoring.

86. The method of claim 83, wherein said non-overlapping monitoring occurs whereby said in-situ monitoring occurs prior to said remote monitoring.

87. The method of claim 50, wherein said remote monitoring comprises cross-reactive monitoring.

88. The method of claim 50, wherein said in-situ monitoring comprises cross-reactive monitoring.

89. The method of claim 50, wherein said remote monitoring and in-situ monitoring comprises cross-reactive monitoring.

90. The method of any one of claims 87, 88 or 89 further comprising updating a list of detectable chemicals that can be added to a lookup library chemical signatures for said cross-reactive monitoring

91. The system of claim 11, wherein the said at least one remote sensor and said at least one in situ sensor are installed to monitor the air flow in ventilation systems to detect the flow of chemicals or pollutants.

92. The system of claim 11, wherein the said at least one remote sensor and said at least one in situ sensor are installed in fixed location to monitor the air inside or outside a closed structure to detect the indoors or outdoors chemicals or pollutants.

93. The system of claim 11, wherein the said at least one remote sensor and said at least one in situ sensor are installed in fixed location to monitor the air along, across or near a fence, wall, or the like.
